(19) United States
(12) Patent Application Publication
(10) Pub. No.: US 2024/0351349 A1
(43) Pub. Date: Oct. 24, 2024

(54) METHOD AND SYSTEM FOR PRINTING ON LABELS

(71) Applicant: ATLANTIC ZEISER GMBH, Emmingen-Liptingen (DE)

(72) Inventors: Sven MARQUARDT, Emmingen- Liptingen (DE); Michael DREXLER, Emmingen- Liptingen (DE)

(73) Assignee: ATLANTIC ZEISER GMBH, Emmingen-Liptingen (DE)

(21) Appl. No.: 18/637,508

(22) Filed: Apr. 17, 2024

(30) Foreign Application Priority Data
Apr. 21, 2023 (IT) 102023000007971

(51) Int. Cl. B41J 3/407; B41J 11/00

(52) U.S. Cl. CPC B41J 3/4075; B41J 11/00214

(57) ABSTRACT

A method for printing on labels applied to cards in a printing system includes at least one inkjet printer, the method also includes supplying to the printing system a card provided with a first surface and a label provided with a first face opposite a second face, engaging the second face of the label on the first surface of the card, so as to apply the label to the card, printing by the at least one inkjet printer the first face of the label applied to the card, removing from the printing system the card bearing the printed label. A printing system is also provided for printing on labels applied to cards, which works with the method.

### CROSS-REFERENCE TO RELATED APPLICATIONS

This application claims benefit to Italian Patent Application No. 102023000007971, filed Apr. 21, 2023, the entire contents of which are fully incorporated by reference herein as if fully set forth.

### FIELD OF THE INVENTION

The present invention is directed to a method and a system for printing on labels applied on cards, in particular on customized cards.

Examples of customized cards are identity cards, health cards, phone cards, credit cards, bank cards, driver's licenses, gift cards, access cards.

This invention is preferably, although not exclusively, applicable in the field of low-volume card customization system. Furthermore, this invention is equally preferably applicable in the field of medium to high volume card customization systems.

### BACKGROUND

Identity cards, health cards, phone cards, credit cards, bank cards, driver's licenses, gift cards, access cards, and various other types of customized cards are generally made of plastic materials, card, metal, or a hybrid material composition (e.g., metal and plastic material), and generally have surfaces that include plastic material.

On the respective surfaces, each customized card contains customization data that can be printed or embedded in the card in different ways, depending on the functionalities and requirements of the security levels.

The customization data includes data belonging to the cardholder such as name, surname, address, telephone number, bank account number, insurance number, identification image. Other customization data include customized strings, images, messages, card number, card expiration date, linear or two-dimensional codes, logos, names.

For some uses of the customized cards of the type mentioned above, it is provided that the card is associated with a label containing data or information normally addressed to the final recipient of the card. The data are printed on the label, for example on the face of the label opposite to that intended to be engaged on a surface of the card. The label is typically applied to the card in a removable manner, for example by means of an adhesive which allows the end user of the card an easy removal of the label.

Labels of the type described comprise, for example, activation labels for credit cards, debit cards, phone cards or other similar type of cards in which it is required to accompany the card with codes or information for the activation of the card contained on the label applied to the card. The label bearing the card activation codes is configured to be removed from the card once the final recipient of the card has completed the card activation operations.

Other information, such as of the advertising type, may also be printed on the label.

The labels designed for the aforementioned uses are generally made of paper material, but they can also be made of plastic material or a hybrid material composition (for example, paper material and plastic material).

For performing the printing on labels, as well as for printing customized cards, printing systems are known that can include one or more Drop-on-Demand (DoD) inkjet printers, which are able to print with selected colors (for example black, white, cyan, yellow, magenta) on the faces of the labels, likewise on the surfaces of the cards, or on parts of them.

The DoD inkjet printer can print using thermal inkjet technology or piezoelectric inkjet printing technology where pressure waves are used to eject selected amounts of ink from the nozzles of the printheads.

The formulation of the ink may vary depending on the type of printhead and the substrate characterizing the labels to be printed. For example, the use of ultraviolet and LED dryable inks is known. In particular, the ultraviolet-dryable ink is preferable since it provides immediate drying, light resistance, high print quality, adhesion, scratch resistance, color density, no volatile organic compound.

To ensure printed labels with an adequate standard of quality, the known label printing system may also include one or more label surface treatment stations, for appropriately treating the surfaces of the labels prior to printing. A surface treatment station may include air cleaning devices, corona treatment devices, plasma treatment devices, air plasma treatment devices, gas plasma treatment devices, as non-limiting examples.

A known system for making customized cards bearing labels applied to them provides that the printing processes of the cards and the printing processes of the labels are carried out in advance, separately from each other, and that only after these printing processes the application of the labels to the respective and corresponding customized cards matched to them is carried out.

In a known system it is envisaged that cards or batches of cards associated with a first card issuer followed by cards or batches of cards associated with a second card issuer are customized. In these processing, the important requirements to be met are to ensure a high-quality printing standard while maintaining a high productivity of the system in terms of printed cards per hour. What is more, both surfaces of a plastic card need to be printed and treated.

The preparation of the labels to be applied to the customized cards requires in turn to print labels or batches of labels, separately from the printing of the cards, providing for a storage of a variety of labels or batches of labels as a function of the information or codes printed on them and directed to be matched to the cards of the corresponding card issuer. Different card issuers generally require corresponding labels different from one another, based on the information or activation codes to be matched to the cards.

Known systems therefore require a management of the label preparation and printing line as well as label storage, in order to efficiently perform the step of applying the labels onto the corresponding customized cards, in the sequence of cards or batches of cards that follow one another in the processing line, with the guarantee of completing the customization of the cards, by applying the labels on the cards, with a high production speed.

It is also necessary to manage the storage of any surplus of labels that may occur upon completion of the application of labels on cards of a first batch, in order to then make the surplus labels available again for application on a subsequent batch of cards of the same issuer.

The need to manage the variety of printed labels and their storage in order to match them, during the step of application to cards, with the corresponding customized cards attributable to card issuers different from one another, requires rather complex management systems that inevitably entail an increase in volumes, space requirements and related costs of the card customization system.

In order to facilitate the understanding of the present invention, the meanings of certain terms and expressions, as used in the present description and claims, are set out below.

The expression “surface of a card” is understood to mean one of the two flat surfaces having the largest area on opposite sides of a card and generally intended to be printed in order to include relevant information.

The expression “face of a label” is understood to mean one of the opposite and flat faces having the largest area on opposite sides of a label.

“Flipping a card” is understood to mean to rotate the card about an axis parallel to the surfaces of the card, in particular to rotate the card 180 degrees around said axis. When a card lying on a plane with its first surface is flipped, the same card lies on the plane with its second surface opposite to said first surface as a consequence of the flipping.

In a card processing system where a card moves in a certain direction along a path, a first station is defined “upstream” of a second station when said first station precedes said second station with reference to said direction, conversely a second station is defined “downstream” of a first station when said second station follows said first station with reference to said direction.

The Applicant has observed that in order to make customized cards provided with labels, it is necessary that each printed card associated with a specific issuer is matched with a respective pre-printed label with the information or activation codes attributable to the corresponding card issuer, so as to be correctly applied to the corresponding customized card. Since each card issuer has its own configuration of labels, for example activation labels, storage of different labels or batches of pre-printed labels must be provided for or prepared in order to allow, if necessary, said labels to be applied on cards or batches of customized cards of the respective issuer.

In a card processing line, for productivity reasons, it can be envisaged to feed customized cards or batches of cards of different issuers, in sequence to each other, by conveying the cards to a station for applying printed labels, where the respective label of a certain card issuer is applied to each card of that issuer. Once the application of the labels on the cards of a first issuer has been completed, the application of the respective labels of a second batch of cards of a second issuer is performed.

The Applicant has also observed that in the card customization systems, in accordance with the known methods, once the application of labels on the cards of a batch attributable to a certain issuer has been completed, there may be a surplus of non-applied labels, which must be put back into storage for use in a possible future processing of a new batch of cards of the same issuer or disposed of as obsolete material.

The Applicant has therefore found that printing labels in advance and subsequently applying them to customized cards, also printed in advance, requires management of the production and storage of a variety of pre-printed labels, which can be rather complex and costly as well as it might affect the productivity of the system for the production of customized cards provided with labels.

The Applicant has also noted that the need to provide for a storage of labels already printed in advance and to be made available when needed, leads to greater volumes and space requirements of the production system, resulting in increased complexity and costs.

The Applicant therefore perceived that it was necessary to provide a method that avoided the need to have to provide for the storage and movement of labels printed in advance for the variety of required configurations to be matched to the customized cards associable with different card issuers, while at the same time ensuring adequate quality in the label printing process and appropriate speed in the production of the customized cards provided with labels.

### SUMMARY

The Applicant has therefore found that a method for printing labels applied to cards, in which the label, before being printed, is applied to a customized card and only after being applied to the card it is it printed, allows to avoid the need to provide for the management and storage of a variety of labels printed in advance with different configurations, the desired configuration (i.e., that containing the codes or information to be reported on the label) being able in fact to be directly printed in line on a label after said label has been applied on the card.

In a first aspect thereof, the invention concerns a method for printing on labels.

Preferably the method is intended for printing on labels applied on cards in a printing system.

Preferably the method comprises supplying to said printing system a card provided with a first surface.

Preferably the method comprises supplying to said printing system a label provided with a first face.

Preferably said first face is opposite a second face.

Preferably the method comprises engaging said second face of said label on said first surface of said card, so as to apply said label on said card.

Preferably the method comprises printing, preferably by said at least one inkjet printer, said first face of said label applied to said card.

Preferably, the method comprises removing from said printing system said card bearing said printed label.

The Applicant has verified that the above-mentioned method guarantees a simplification of the system of customization of the cards provided with labels, in particular reducing the complexity of the aspects inherent in the production and storage of printed labels to be applied on the cards, resulting in a system of customization of cards provided with labels with a significantly reduced space requirement and cost, while at the same time guaranteeing high printing quality standards and system productivity in terms of volumes of cards printed per hour.

The Applicant has also verified that the method of the claimed invention allows to overcome the problems related to the need to support the label by adjusting the relative tension of the label while being conveyed and providing an adequate support surface for the label during printing thereof. Printing the label when it has already been applied to the card allows in fact to take advantage of the support action provided by the card being moved along the processing line, with consequent construction simplification and relative reduction of space requirements and costs.

In a second aspect thereof, the invention concerns a printing system for printing on labels.

Preferably the printing system is designed to print on labels applied to cards.

Preferably said printing system includes a card feeding station configured to feed cards into said printing system.

Preferably said printing system includes a card output station to remove cards from said printing system.

Preferably said printing system includes a conveying device configured to convey the cards along a path. Preferably said path is extended between said card feeding station and card output station.

Preferably said printing system includes a label feeding station.

Preferably said label feeding station is configured to feed labels to a label application station for applying labels on said cards.

Preferably said label application station is configured to apply a label to a respective card.

Preferably said printing system includes a printing station.

Preferably said printing station is placed downstream of said label application station along said path.

Preferably said printing station is configured to print on the label applied to the card.

The present invention in at least one of the aspects mentioned above may have at least one of the preferred features set out below.

In a preferred embodiment, the label is removably engaged on the first surface of the card.

In a preferred embodiment, the label is engaged with adhesive on the first surface of the card.

In a preferred embodiment, said first face of said label is applied on a portion of said first surface of said card.

In a preferred embodiment, said method comprises performing a surface treatment on at least the first face of the label before said printing said first face.

In a preferred embodiment, said method comprises performing an ink drying treatment on said printed label.

In a preferred embodiment, the ink drying treatment is an ultraviolet ink drying treatment.

In a preferred embodiment, the card is moved in the printing system along a path. Preferably said path is straight.

In a preferred embodiment, said printing is carried out while the card, to which said label is applied is moved at a constant speed.

In a preferred embodiment, the card is moved, before and after said printing, with a variable speed movement.

In a preferred embodiment, said variable speed movement provides alternating speed. Preferably said alternating speed creates an intermittent movement.

Thanks to this feature, a reduction in space requirements and costs of the printing system is achieved. Creating intermittent movements, with alternating speeds, in particular with alternating stops and restarts, advantageously allows to limit the spaces provided along the system processing line.

In a preferred embodiment, said intermittent movement is created at a variable speed between a first speed and a second speed.

In a preferred embodiment, said second speed has zero value.

In a preferred embodiment, the variable speed of the card is zero during the application of the label on the card.

In a preferred embodiment, the variable speed of the card on which the label is applied is zero during a drying treatment, preferably in an ink drying treatment on said printed label.

In a preferred embodiment, said method comprises performing a verification on said printed label.

In a preferred embodiment, said method comprises performing a verification on said card on which said printed label is applied.

In a preferred embodiment, said method comprises performing a verification on at least one of said printed label and said card on which said printed label is applied.

In a preferred embodiment, said verification is performed by means of an optical vision system.

In a preferred embodiment, said method comprises providing a printing area delimited by a printing perimeter within said first face of said label. Preferably said printing perimeter is spaced from an edge of said first face by a predetermined non-zero distance. Preferably printing said first face of said label applied on said card comprises performing a printing within said printing area. Preferably said predetermined distance is constant, equally preferably said predetermined distance is variable.

Advantageously, this allows facilitating the identification of the edge of the label in order to simplify the removal of the label from the card by the end user.

In a preferred embodiment, printing said first face of said label applied on said card comprises performing a printing within said printing area.

In an equally preferred embodiment, printing said first face of said label applied on said card comprises performing a printing exclusively within said printing area.

In a preferred embodiment, said method comprises preparing a printing system including a card feeding station, a label feeding station, a label application station for applying labels on cards, a printing station, a card output station.

In a preferred embodiment, said method comprises feeding a card at said card feeding station.

In a preferred embodiment, said method comprises feeding a label at said label feeding station.

In a preferred embodiment, said method comprises conveying said card and said label at said label application station for applying labels on cards.

In a preferred embodiment, said method comprises transferring said card bearing the label thereon applied in said printing station.

In a preferred embodiment, said printing station comprises at least one inkjet printer, i.e., said printing system comprises at least one inkjet printer. Preferably said inkjet printer is of the Drop-on-Demand type. Preferably said ink is ultraviolet dryable.

In a preferred embodiment, said printing system comprises a label drying station. Preferably said label drying station is arranged downstream of the printing station along said path.

In a preferred embodiment, said printing system comprises a printing verification station. Preferably said printing verification station is arranged downstream of the drying station along said path.

In a preferred embodiment, said printing verification station comprises an optical acquisition device.

In a preferred embodiment, said optical acquisition device is provided with optical filters.

In a preferred embodiment, said printing system comprises a label surface treatment station arranged between the label application station for applying labels on the card and the printing station along said path.

In a preferred embodiment, said conveying device comprises at least one of a conveyor, a tape, a track system and a shuttle.

### BRIEF DESCRIPTION OF THE DRAWINGS

The features and advantages of the invention will become better apparent from the detailed description of some preferred embodiments thereof, which are illustrated by way of non-limiting example with reference to the accompanying drawings, in which:

FIG. 1 is a schematic representation of a first example of a system for printing on labels applied to cards operating according to a method for printing on labels in accordance with the present invention,

FIG. 2 is a schematic representation of a second example of a system for printing on labels applied to cards operating according to a method for printing on labels in accordance with the present invention,

FIGS. 3A and 3B are plan views respectively of a first and a second surface opposite the first surface of a card provided with a label applied and printed thereon by means of a label printing method and system in accordance with the present invention, and

FIG. 4 is a perspective view of the card and label of FIGS. 3A and 3B shown separated from each other.

### DETAILED DESCRIPTION OF THE PREFERRED EMBODIMENTS

The headings used herein are for organizational purposes only and are not meant to be used to limit the scope of the description or the claims. As used throughout this application, the words “may” and “can” are used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the figures.

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

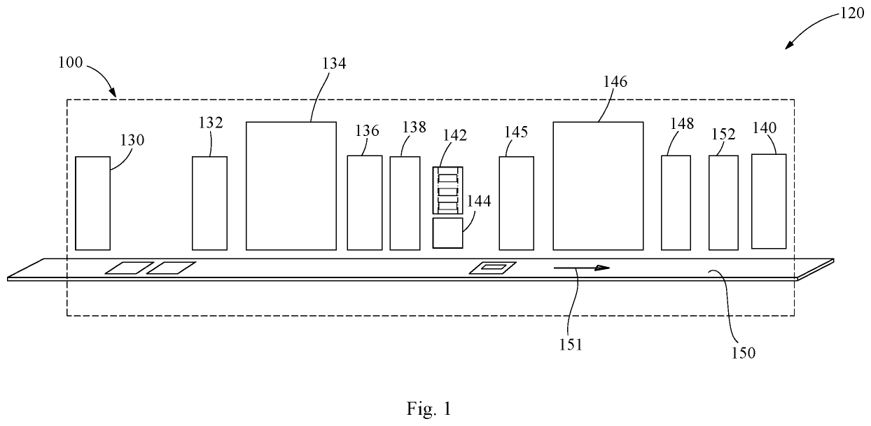

With initial reference to FIG. 1, a first example of a printing system made to operate according to the method of the present invention is overall marked with 100.

The printing system 100 is part of a card customization system 120 and comprises a first and a second printing module, respectively dedicated to printing on cards and printing on labels applied to the cards.

The printing system 100 comprises a card feeding station 130 configured to feed cards into the printing system and a card output station 140 configured to remove the cards from the printing system.

The card feeding station 130 includes manipulation or pushing devices intended to feed a card, for example taken from a stack of cards (not illustrated), to the subsequent stations.

A conveying device, indicated globally with 150, is configured to convey the cards from the card feeding station 130 to the card output station 140, along a straight path 151 in the direction identified by the arrow of FIG. 1 or in the opposite direction based on the processing to be performed on the cards within the printing system 100.

The conveying device 150 can include belt or tape conveyor systems on which the cards are positioned and possibly retained with suitable systems, for example with vacuum gripping systems by means of air suction, or it can include systems with shuttle moved on tracks with suitable means for supporting the cards and for aligning them along the path.

With reference to the first printing module intended for printing cards, the printing system 100 comprises a surface treatment station 132 intended for card surface treatment, a printing station 134 intended for printing on cards, a drying station 136 for drying ultraviolet dryable ink, and a card flipping station 138.

The cards have a first surface 1a and a second surface 1b, opposite each other and both configured to be subjected to the printing process.

In the surface treatment station 132 of the first printing module, devices are provided for performing a treatment on one or both surfaces of the card, said devices performing for example plasma surface treatments on the surface of the card.

The printing station 134 of the first printing module includes one or more printers which are provided with one or more printheads. Preferably, the printers are Drop-on-Demand (DoD) inkjet printers that use ultraviolet dryable ink.

In the drying station 136 of the first printing module, placed downstream of the printing station 134 of the same first printing module, the ink deposited on the card in the printing process is dried and cured by UV rays.

In the card flipping station 138 of the first printing module, manipulation or pushing devices configured to flip the card, in particular rotate the 80° around an axis parallel to the surface of the card, are provided. The card, once flipped, can be conveyed backwards along the path 151, in the direction opposite to the direction of the arrow shown in FIG. 1, to be fed again into the printing station 134 of the first printing module in order to print the surface of the card opposite to the one previously printed.

In the first printing module, the printing system 100 may comprise a further processing station (not depicted) intended to operate an additional processing on the cards. The further processing station of the first printing module is arranged downstream of the printing station 134 of the same first printing module and it may be one or more of a chip programming station, a laser marking station, a magnetic stripe encoding station, a printing verification station, a card sorting station.

Once the printing of the card, carried out on one or both surfaces of the card, has been completed, the card is conveyed to the second printing module, placed downstream of the first module and prepared for printing labels.

The labels have a first face 2a and a second face 2b, opposite each other.

With reference to the second printing module provided for printing labels, the printing system 100 comprises a label feeding station 142 configured to feed labels to a label application station 144. In the label feeding station 142, devices are provided for moving label holder supports, for example in the form of reels for winding strips or tapes of labels.

The label application station 144 comprises devices for applying the label on the card, removing the label from its label holder support and engaging it on the corresponding card, in particular by engaging the face 2b of the label on the surface 1a of the card. The label is removably engaged to the card by adhesive. The adhesive can be provided on the face 2b already during the production of the label.

In the second printing module, the printing system 100 comprises a surface treatment station 145 intended for label surface treatment, a printing station 146 intended for printing on labels applied to the cards, a drying station 148 for drying ultraviolet dryable ink and a printing verification station 152, for verifying the printing result on the printed label and possibly the result of the set of card and printed label.

In the surface treatment station 145 of the second module devices are provided for performing a treatment, in particular a cleaning surface treatment for the face of the label intended to be printed.

The printing station 146 of the second module includes one or more printers which are provided with one or more printheads. Preferably, the printers are Drop-on-Demand (DoD) inkjet printers that use ultraviolet dryable ink.

In the drying station 148 of the second module, placed downstream of the printing station 146 of the same second module, the ink deposited on the label in the printing process is dried and cured by UV rays.

The printing verification station 152 comprises at least one optical vision system, for example including an optical acquisition device for acquiring images of the printed label and possibly of the set of card and printed label, in order to carry out a control of the quality of printing performed on the label and of the overall result of the processes performed in the first printing module and in the second printing module. The optical acquisition device may be provided with optical filters.

In the operation of the printing system 100, once the printing of the cards in the first printing module has been completed, by printing on both surfaces of the card if provided, the cards are conveyed along the straight path 151 in the second printing module, dedicated to printing on labels. The movement of the cards is performed with a configuration of cards aligned with each other, in a single row, along the direction of the straight path 151.

Along the path, the cards are moved with alternating continuous movements, i.e., at constant speed, and intermittent ones, i.e., with variable speed.

In greater detail, the movement of the card, during the step of printing the label applied to the card, is a continuous movement performed at a constant speed. For example, it may be provided that the conveying device comprises a conveying belt extended for a section of the path in which the card transits at the station for printing on the label, and said belt, on which the cards are positioned, is carried with a continuous movement at a constant speed.

Before and after the step of printing on the label, the cards are carried with an intermittent movement with which the card is subject to stops and restarts, obtained with a variable speed movement of the card conveying device. Said variable speed can assume values between a first and a second speed and the stop of the movement corresponds to a zero-speed value.

A stop of the movement is provided at the label application station 144, i.e., when a label is applied on the respective card, for the duration of step of application of the label itself.

A stop of the movement is provided at the drying station 148 of the second module, for the duration of the step of drying the ink deposited on the label during printing.

A stop of the movement is further provided at the printing verification station 152 for verifying the printing on the applied label and printed on the card in the second module, for the duration of the label verification step.

A stop of the movement is further provided at the card output station 140, where the cards are extracted from the printing system and collected by stacking.

For the intermittent movement of the cards it is provided for the use of belts configured to advance the cards by exerting a thrust on the opposite side edges of the card.

It should be observed that the face of the label intended to be printed may be blank or white, i.e., devoid of any marks or patterns, e.g. previously printed. Or, alternatively, the face of the label to be subjected to printing may comprise marks, logos, patterns or backgrounds already made in advance, for example by printing, which may or may not identify blank zones of the label having a width less than the width of the face of the label, on which it is envisaged printing after the label has been applied to the corresponding card.

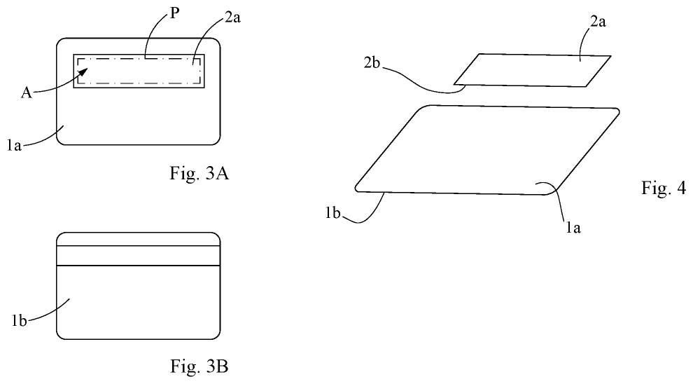

With reference to FIG. 3A, in which the surface 1a of the card on which the label is applied is visible, it is envisaged that on the face 2b of the label intended to be printed there is defined a printing area, indicated with A, delimited by a printing perimeter P (depicted with a dot-and-dash line). The printing perimeter P is spaced from the edge of the face 2a by a predetermined distance, not zero and of small size, and it is envisaged that the printing on the label is performed exclusively within the printing area, without crossing over in the frame zone defined between the printing perimeter P and the edge of the face 2a of the label. This makes it possible to avoid that the printing on the label can extend up to the edge of the label, with the risk of crossing over and consequently contaminating or soiling the surface 1a of the card, while at the same time making the outline of the label (defined by the margin of the label outside the printing area) clearly visible in order to facilitate the identification of the edge of the label to be lifted in order to remove the label from the card.

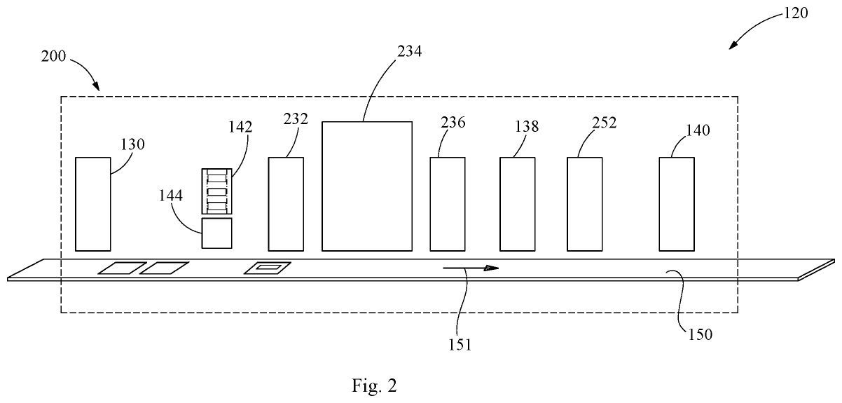

With reference to FIG. 2, a second example of a printing system made to operate according to the method of the present invention is overall marked with 200.

In this second embodiment, details similar to those described in the previous example are marked with the same numerical references.

The printing system 200 differs from the previous one mainly in that it provides for a single printing station comprising a printer intended to operate both for printing cards and for printing on labels applied to the cards.

The label feeding station 142 and the label application station 144 are arranged downstream of the card feeding station 130.

With 232 a surface treatment station is marked which can be configured to perform surface treatments on the surfaces of the cards, prior to printing them, as well as to perform surface treatments on the label applied to the card, for example directed to cleaning treatments for the face of the label intended to be printed.

The printing system 200 comprises a printing station 234 including one or more printers, having characteristics similar to those described in the previous example and arranged to print both the cards and the labels applied to the cards. A Drop-on-Demand (DoD) inkjet printer that uses ultraviolet dryable ink is preferably provided.

The printing system 200 further comprises a drying station 236 for drying the ink deposited on the cards or on the labels in the respective printing steps, a verification station 252 for verifying the printing of the cards and of the labels applied to the cards.

The card flipping station 138 is arranged downstream of the drying station 236.

Downstream of the printing verification station 252 there is arranged the output station 140 for the extraction of the cards once the printing of the labels on the cards has been completed.

In the operation of the printing system 200, the provision of a single printer dedicated to both printing the cards and the labels applied to the cards, requires that the card be made to transit at the printing station several times, in order to print one or both of the opposite surfaces of the card, if required (by flipping the card), and to print the label after it has been applied to the respective card. This sequence of processing requires that the card be returned upstream of the printing station, in a backward movement along the path, in the direction opposite to the direction marked by the arrow in FIG. 2, each time it must be subjected to a printing step in order to print on one of the surfaces of the card or on the label applied to the card.

The card is conveyed along the path defined between the card feeding station 130 and the card output station 140, with alternating continuous and intermittent movement in a manner completely analogous to that already described in the previous example.

Advantageously, the printing system of this embodiment, by providing a single printing station, is characterized by a reduction in space requirement as well as a construction simplification that is also reflected in a reduction in costs.

It is understood, therefore, that this invention is not limited to the particular embodiments disclosed, but is intended to cover all modifications which are within the spirit and scope of the invention as defined by the appended claims; the above description; and/or shown in the attached drawings.

1. A method for printing on labels applied to cards in a printing system, wherein the printing system comprises at least one inkjet printer, wherein the method comprises:
supplying to said printing system a card provided with a first surface and a label provided with a first face opposite a second face;
engaging said second face of said label on said first surface of said card, so as to apply said label to said card;
printing by said at least one inkjet printer said first face of said label applied to said card,
removing from said printing system said card bearing said printed label.

2. The method according to claim 1, wherein said label is removably engaged on said first surface of said card.

3. The method according to claim 1, wherein the method further comprises the step of performing a surface treatment on at least said first face of said label before said printing said first face.

4. The method according to claim 1, wherein the method further comprises the step of performing an ink drying treatment on said printed label.

5. The method according to claim 1, wherein said card is moved in said printing system along a straight path.

6. The method according to claim 1, wherein said printing is carried out while said card, to which said label is applied, is moved at a constant speed.

7. The method according to claim 1, wherein said card is moved, before and after said printing, with a variable speed movement.

8. The method according to claim 7, wherein said variable speed movement provides alternating speeds creating an intermittent movement.

9. The method according to claim 8, wherein said intermittent movement is made at a variable speed comprised between a first speed and a second speed.

10. The method according to claim 9, wherein said second speed has a zero value.

11. The method according to claim 7, wherein said variable speed of said card is zero when said label is being applied to said card.

12. The method according to claim 7, wherein said variable speed of said card to which said label is applied is zero during an ink drying treatment of said printed label.

13. The method according to claim 1, wherein the method further comprises the step of providing a printing area delimited by a printing perimeter within said first face of said label, wherein said printing perimeter is spaced from an edge of said first face by a predetermined non-zero distance, wherein printing said first face of said label applied to said card comprises performing a printing within said printing area.

14. A printing system for printing labels applied to cards, the system comprising:
a card feeding station configured to feed cards into said printing system,
a card output station to remove cards from said printing system,
a conveying device configured to convey said cards along an extended path between said card feeding station and card output station,
a label feeding station configured to feed labels to a label application station for applying labels on said cards, wherein said label application station is configured to apply a label to a respective card,
a printing station comprising at least one inkjet printer, placed downstream of said label application station along said path and configured to print on said label applied to said card.

15. The printing system according to claim 14, wherein said at least one inkjet printer is a Drop-on-Demand ink jet printer.

16. The printing system according to claim 14, wherein said at least one inkjet printer is an ultraviolet dryable ink jet printer.

17. The printing system according to claim 14, wherein the printing system further comprises a drying station arranged downstream of said printing station along said path.

18. The printing system according to claim 17, wherein the printing system further comprises a printing verification station, arranged downstream of said drying station along said path.

19. The printing system according to claim 14, wherein said path is straight.

20. The printing system according to claim 14, wherein the printing system further comprises a surface treatment station arranged between said label application station for applying labels to a card and said printing station along said path.
